(19) United States
(12) Patent Application Publication
(10) Pub. No.: US 2009/0049940 A1
(43) Pub. Date: Feb. 26, 2009

(54) DRIVE POWER TRANSFER APPARATUS

(75) Inventor: Koji TAKAIRA, Okazaki-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/192,153

(22) Filed: Aug. 15, 2008

(30) Foreign Application Priority Data
Aug. 23, 2007 (JP) 2007-217286

(51) Int. Cl. F16H 35/08

(52) U.S. Cl. 74/395

(57) ABSTRACT

A drive power transfer apparatus is provided which has an elastic portion provided between a differential-lock switching shift folk and a stopper portion and a support portion provided between the differential-lock switching shift folk and the elastic portion. The stopper portion has a first contact portion that contacts the elastic portion and a second contact portion which protrudes toward the differential-lock switching shift folk more than the first contact portion does and which contacts the support portion. The differential-lock switching shift folk is set in position by the elastic portion contacting the first contact portion. The thickness of the elastic portion in the axial direction is larger than the distance between the first contact portion and the second contact portion in the axial direction. According to this structure, the switching mechanism of the drive power transfer apparatus can be operated without making any impact noise.

### INCORPORATION BY REFERENCE

The disclosure of Japanese Patent Application No. 2007-217286 filed on Aug. 23, 2007, including the specification, drawings and abstract is incorporated herein by reference in its entirety.

### BACKGROUND OF THE INVENTION

1. Field of the Invention

The invention relates to a drive power transfer apparatus.

2. Description of the Related Art

A drive power transfer apparatus is known which has a main transmission unit having multiple transmission speeds and a two-speed sub-transmission unit having a high transmission speed and a low transmission speed. According to this drive power transfer apparatus, a high transmission speed ratio can be achieved with a relatively simple structure.

In such a drive power transfer apparatuses, the shift operation of the main transmission unit and the shift operation of the sub-transmission unit are independently controlled, and upon off-road drive such as when running on a rough road, a road covered with rocks and gravels, or the like, the sub-transmission is switched from HIGH mode, which provides a high transmission speed, to LOW mode, which provides a low transmission speed, establishing a speed-reduction ratio higher than normal, so that the vehicle runs in the four-wheel drive mode with sufficient drive power. Further, the drive mode is switched between the two-wheel drive mode and the four-wheel drive mode using a switching mechanism provided in the transfer, and the center differential is switched between the locked state and the unlocked state using a switching mechanism provided in the transfer.

In such a drive power transfer apparatus, typically, a switching sleeve for switching the operation mode of the sub-transmission unit between HIGH mode and LOW mode and a switching sleeve for coupling and decoupling the front-wheel drive shaft and the rear-wheel drive shaft are moved by rotational force of a shift motor serving as an actuator for quick switching operation (For example, refer to Japanese Patent Application Publication 2001-280491 (W-A-2001-280491)).

FIG. 10 is a view illustrating a switching mechanism incorporated in a conventional drive power transfer apparatus. This switching mechanism has a first gear 97, a second gear 98, a switching sleeve 95 and a shift folk 96 that are movable between a position where the switching sleeve 95 meshes with one of the first gear 97 and the second gear 98 and a position where the switching sleeve 95 meshes with both of the first gear 97 and the second gear 98, an actuator 92 and a shift shaft 93 used to drive the switching sleeve 95 and the shift folk 96, and a stopper portion 94 that defines the end of the movable range of the switching sleeve 95 and the shift folk 96. According to this switching mechanism, the drive-power transmission path between the first gear 97 and the second gear 98 is connected and disconnected by moving the switching sleeve 95 and the shift folk 96 using the actuator 92 as needed to switch the operation mode of the sub-transmission unit between HIGH mode and LOW mode. More specifically, when switching the operation mode of the sub-transmission unit, for example, as the actuator 92 is driven, the switching sleeve 95 moves on the first gear 97 and then stops temporarily when it contacts the second gear 98. The actuator 92 continues to be driven for a certain amount to wind an internal spring (not shown in the drawing) in the actuator 92 after the switching sleeve 95 stops. Then, when the phase of the spline of the switching sleeve 95 and the phase of the spline of the second gear 98 match each other, the switching sleeve 95 moves onto the second gear 98 in moment due to the urging force of the internal spring of the actuator 92 and then stops by contacting the stopper portion 94.

According to conventional drive power transfer apparatuses such as the one described above, however, upon switching operation, an impact noise is made when the switching sleeve 95 hits the stopper portion 94 defining the end of the movable range of the switching sleeve 95, and it may make the occupants of the vehicle feel uncomfortable.

### SUMMARY OF THE INVENTION

In view of the above issue, the invention has been made to provide a drive power transfer apparatus incorporating a switching mechanism that can be operated without making any impact noise.

The first aspect of the invention relates to a drive power transfer apparatus, having: a first gear; a second gear that is coaxial with the first gear; a movable portion that is moved in an axial direction of the first gear and the second gear between a first position where the movable portion meshes with one of the first gear and the second gear and a second position where the movable portion meshes with both of the first gear and the second gear; a driving device that moves the movable portion; a positioning portion that sets the movable portion in one of the first position and the second position; an elastic portion that is provided between the movable portion and the positioning portion; a support portion that is provided between the movable portion and the elastic portion; a first contact portion that contacts the elastic portion; and a second contact portion that protrudes toward the movable portion more than the first contact portion does and that contacts the support portion, wherein the movable portion is set in one of the first position and the second position by the elastic portion contacting the first contact portion.

According to the drive power transfer apparatus described above, because the movable portion contacts the positioning portion via the elastic portion, any impact noise is not made when the movable portion is moved to switch the drive power transfer mechanism. Further, when the elastic portion has been worn to an extent that the elastic portion does not contact the first contact portion any more, the movable portion is set in the position by the support portion contacting the second contact portion. As such, even if the elastic portion has been worm, the precision of the switching operation of the drive power transfer apparatus is kept high, and therefore it can be switched properly.

The above-described drive power transfer apparatus may be such that the thickness of the elastic portion in the axial direction is larger than the distance between the first contact portion and the second contact portion in the axial direction.

According to this structure, when the elastic portion has not yet been worn and thus the axial thickness of the elastic portion is still larger than the axial distance between the first contact portion and the second contact portion, the movable portion is set in position by the first contact portion contacting the elastic portion, and due to the elastic portion, the movable portion and the positioning portion do not make any impact noise. Conversely, when the elastic portion has been worn, the movable portion is set in position by the second contact portion contacting the support portion, and therefore the stop position of the movable position slightly shifts as long as the elastic portion has been worn. However, even in this case, because the movable portion is set in position by the second contact portion contacting the support portion, the precision of the switching operation is kept high and therefore the drive power transfer apparatus can be properly switched.

Further, the above-described drive power transfer apparatus may be such that the elastic portion and the support portion are integrated with each other.

According to this structure, because the elastic portion is supported by the first contact portion, the elastic portion does not deform nor break.

Further, the above-described drive power transfer apparatus may be such that the support portion and the movable portion are integrated with each other.

According to this structure, it is possible to prevent even a slight noise that may be caused when the movable portion and the support portion contact each other when the movable portion is being moved.

Further, the above-described drive power transfer apparatus may be such that the support portion and the movable portion are integrated with each other and the elastic portion is secured to the first contact portion.

According to this structure, because the elastic portion is supported by the first contact portion, the elastic portion does not deform nor break, and it is possible to prevent even a slight noise that may be caused when the movable portion and the support portion contact each other.

According to the invention, as described above, the drive power transfer apparatus has the elastic portion provided between the movable portion and the positioning portion and the support portion provided between the movable portion and the elastic portion, and the positioning portion has the first contact portion that contacts the elastic portion and the second contact portion which protrudes toward the movable portion more than the second contact portion does and which contacts the support portion, and the movable portion is set in position by the elastic portion contacting the first contact portion. Therefore, the movable portion contacts the positioning portion via the elastic portion. As such, the switching mechanism of the drive power transfer apparatus can be switched without causing any impact noise.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a block diagram schematically showing a vehicle incorporating a drive power transfer apparatus according to the first example embodiment of the invention;

FIG. 2 is a cross-sectional view showing the drive power transfer apparatus according to the first example embodiment of the invention and including a block diagram indicating the structural elements for switching control;

FIG. 3 is an enlarged view of an actuator of the drive power transfer apparatus of the first example embodiment of the invention;

FIG. 4 is a view illustrating the state of the drive power transfer apparatus of the first example embodiment of the invention before the differential lock is switched from the unlocked state to the locked state;

FIG. 5 is a view illustrating the state of the drive power transfer apparatus of the first example embodiment of the invention where the deferential lock is being switched from the unlocked state to the locked state;

FIG. 6 is a view illustrating a state of the drive power transfer apparatus of the first example embodiment of the invention after the differential lock has been switched from the unlocked sate to the locked state;

FIG. 7 is another view illustrating a state of the drive power transfer apparatus of the first example embodiment of the invention after the differential lock has been switched from the unlocked sate to the locked state;

FIG. 8 is a view showing a deferential-lock switching mechanism of a drive power transfer apparatus according to the second example embodiment of the invention;

FIG. 9 is a view showing a deferential-lock switching mechanism of a drive power transfer apparatus according to the third example embodiment of the invention; and

FIG. 10 is a view illustrating a switching mechanism incorporated in a conventional drive power transfer apparatus.

### DETAILED DESCRIPTION OF THE EMBODIMENTS

In the following description and the accompanying drawings, the present invention will be described in more detail with reference to exemplary embodiments.

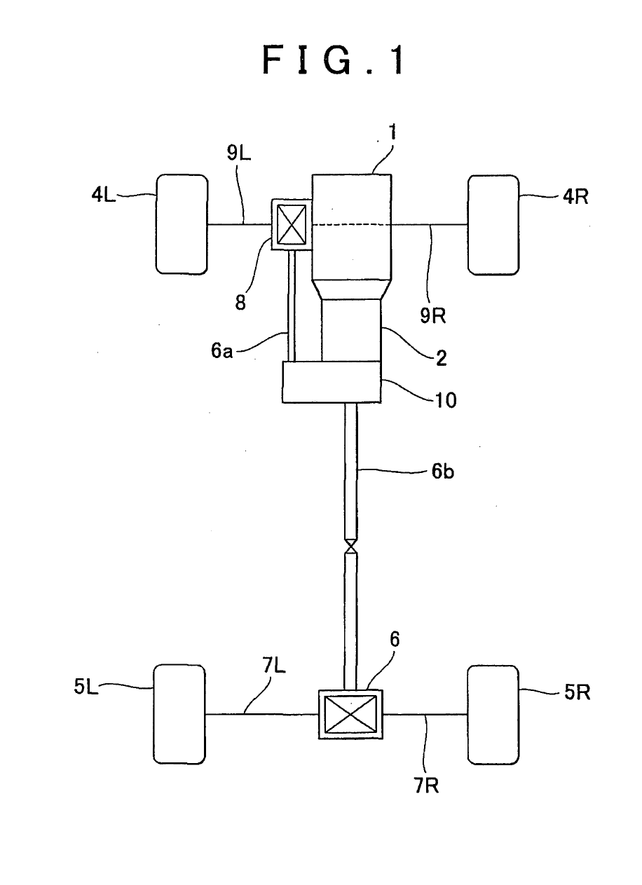

FIG. 1 is a block diagram schematically showing a vehicle incorporating a drive power transfer apparatus according to the first example embodiment of the invention. First, the structure of the drive power transfer apparatus will be described. Referring to FIG. 1, a transfer 10, which is the drive power transfer apparatus, is provided in series after a main transmission unit 2 such that the drive power input from an engine 1 via the main transmission unit 2 is transferred to front wheels 4L, 4R and rear wheels 5L and 5R via the transfer 10. The transfer 10 distributes the input drive power to the front wheels 4L, 4R via a propeller shaft 6a and to the rear wheels 5L, 5via a propeller shaft 6b. The drive power distributed to the rear-wheel side is transferred from a rear differential unit 6 to the rear wheel 5L via a drive shaft 7L and to the wear wheel 5R via a drive shaft 7R, and the drive power distributed to the front-wheel side is transferred from a front differential unit 8 to the front wheel 4L via a drive shaft 9L and to the front wheel 4R via a drive shaft 9R.

The main transmission unit 2 is a known transmission unit and therefore its structure is not described in detail in this specification. In operation, the main transmission unit 2 is selectively shifted to one of multiple drive ranges (multiple forward drive ranges “D”, “L”, and “2”, a reverse drive range “R”, etc.) and a neutral range (“N” range). When the main transmission unit 2 is at one of such drive ranges, it automatically shifts using the transmission speeds of the selected drive range.

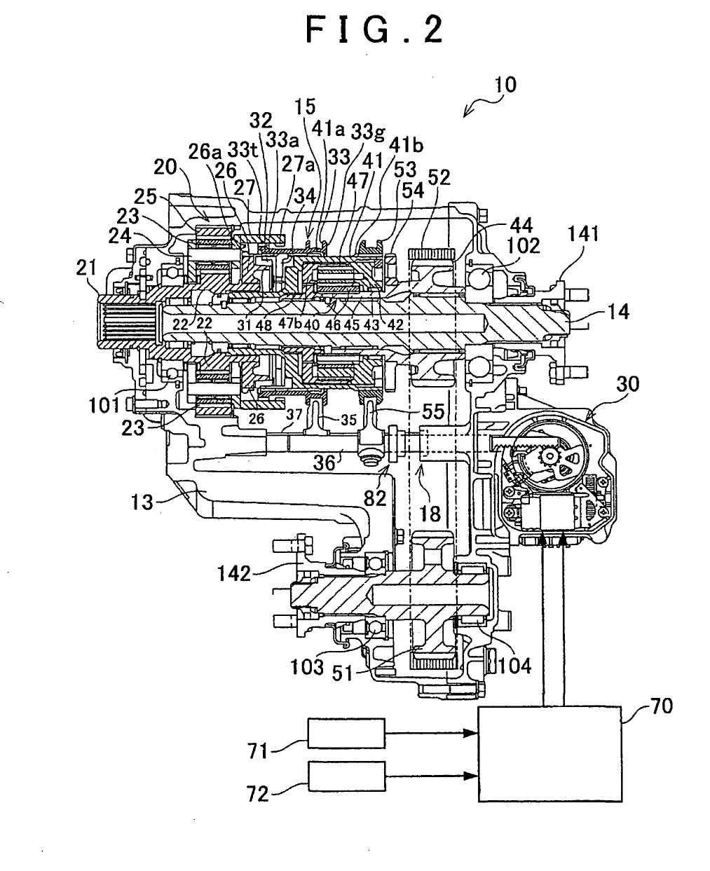

FIG. 2 is a cross-sectional view of the transfer 10 which is the drive power transfer apparatus according to the first example embodiment of the invention. Note that a block diagram indicating the structural elements for switch control of the transfer 10 is also shown in FIG. 2. Referring to FIG. 2, the transfer 10 incorporates a sub-transmission unit 20 that is a drive power transfer mechanism switched between a “HIGH” mode in which the drive power input to the sub-transmission unit 20 is transferred to an output shaft 14 at a high speed and a “LOW” mode in which the drive power input to the sub-transmission unit 20 is transferred to the output shaft at a low speed. The transfer 10 also has a synchronization mechanism 15 provided at an operation portion that is operated to switch the operation mode of the sub-transmission unit 20, an actuator 30 that is driven to actuate the sub-transmission unit 20 to be actually switched via the synchronization mechanism 15, and a center differential 40 that is a differential gear unit incorporating a planetary gearset and having a limited-slip function.

A transfer ECU 70 for controlling the driving of the actuator 30 is connected to the transfer 10. The hardware configuration of the transfer ECU 70 is not described in detail. For example, the transfer ECU 70 is constituted of a CPU (Central Processing Unit), a ROM (Read Only Memory), a RAM (Random Access Memory), a B-RAM (Back-up RAM) that is a back-up memory powered by a battery, an input interface circuit including A/D converters, etc., an output interface circuit incorporating a relay circuit, etc., and a communication interface used for communication with other. ECUs and integrated control computers for controlling the engine 1 and the main transmission unit 2. The transfer ECU 70 may be incorporated in an integrated control computer for transmission control. The transfer ECU 70 is also connected to a HIGH-LOW switch 71 and a differential-lock switch 72 both provided in a passenger compartment of the vehicle (not shown in the drawings).

The sub-transmission unit 20 is constituted of a planetary gearset having a sun gear 22 integrally formed on a cylindrical input shaft 21 splined to an output shaft (not shown in the drawings) of the main transmission unit 2, a plurality of pinions 23 provided around the sun gear 22, a carrier 24 on which the pinions 23 are supported at given intervals, and a ring gear 25 fixed on the inner side of a transfer case 13 and meshing with the pinions 23. In operation, the carrier 24 rotates once every time the cylindrical input shaft 21 rotates more than once, for example, 2.6 times. That is, the sub-transmission unit 20 decelerates the speed of rotation transmitted therethrough, and the decelerated rotation is output from a cylindrical member 27 (toothed low-speed output member) fixed to the carrier 24. A spline 27a is provided at the inner peripheral face of the front end of the cylindrical member 27.

A high-speed toothed wheel 26 (toothed high-speed output member) is fixed to the inner end of the cylindrical input shaft 21 (the end of the cylindrical input shaft 21 on the inner side of the transfer 10). The high-speed toothed wheel 26 is adapted to output the rotation of the cylindrical input shaft 21 via the synchronization mechanism 15 without changing the rotation speed (speed ratio 1:1). The gears of the sub-transmission unit 20 are helical gears, for example.

The synchronization mechanism 15 is of a lever-synchronization type, having a taper ring 31 attached on the inner face of the high-speed toothed wheel 26, a synchronizer ring 32 provided near the taper ring 31, an H-L switching sleeve 33 coaxial with the cylindrical input shaft 21 and serving as a synchronization sleeve, a synchronization lever 34 movably fit, at the outer peripheral side, in an annular groove formed in the inner peripheral face of the H-L switching sleeve 33 and elastically supported, at the inner peripheral side, by a plate spring, or the like, an H-L switching shift folk 35 engaged with an annular switching operation portion 33g of the H-L switching sleeve 33 to move the H-L switching sleeve 33 in the axial direction, and an H-L switching shaft 37 supporting the H-L switching shift folk 35 and supported by the transfer case 13 so as to be slidable in the axial direction. Two splines 33a are formed in the inner peripheral portion of the H-L switching sleeve 33 at a given interval in the axial direction, and the aforementioned annular groove is formed between them.

A spline 33t is provided at the outer peripheral face of the outer end portion of the H-L switching sleeve 33, and the spline 33t meshes with the spline 27a of the cylindrical member 27. As the H-L switching sleeve 33 moves away from the spline 26a of the high-speed toothed wheel 26 toward the actuator 30 side (to the right in FIG. 2), the H-L switching sleeve 33 and the cylindrical member 27 are splined to each other via the splines 33t, 27a to rotate in the same direction.

The center differential 40 has: a housing 41 which is rotatably supported on the output shaft 14 arranged coaxially with the cylindrical input shaft 21 to transmit drive power to the rear side and splined, at the outer peripheral portion thereof, to the inner peripheral portion of the H-L switching sleeve 33; a lid-shaped carrier 42 splined to the inner peripheral portion of one end of the housing 41 and retained by the housing 41 and rotatably supported on a front output member 45 via a bearing; a plurality of pinions 43 (e.g., helical gears) rotatably supported on the carrier 42 so as to be equiangular about the output shaft 14; the front output member 45 coupled with a chain sprocket 44 for front drive and rotatably supported on the output shaft 14; a sun gear 46 splined to the front output member 45 and having outer gear teeth meshing with the pinions 43; a ring gear 47 having an annular plate portion 47b facing one end of each pinion 43; and an inner cylindrical portion 48 splined to the annular plate portion 47b of the ring gear 47 and to the output shaft 14.

The chain sprocket 44 is connected to a driven-side chain sprocket 51 via a chain 52, and the front propeller shaft 6a is driven via the driven-side chain sprocket 51. The rear propeller shaft 6b is connected to the output shaft 14. As the H-L switching sleeve 33 moves to the actuator 30 side, the inner peripheral portion of the H-L switching sleeve 33 engages the spline 41a of the housing 41, whereby the H-L switching sleeve 33 and the housing 41 are splined to each other to rotate in the same direction.

As the revolution of the pinions 43 is input to the center differential 40 via the housing 41 and the carrier 42, the input rotation is transmitted from the sun gear 46 to the front output member 45 and from the ring gear 47 to the output shaft 14 via the inner cylindrical portion 48 while allowing differential motion between the chain sprocket 44, which rotates together with the sun gear 46, and the output shaft 14, which rotates together with the ring gear 47. The center differential 40 restricts the differential motion between the front wheels and the rear wheels within a certain range by pressing the annular plate portion 47b of the ring gear 47 toward the inner face of the housing 41 using the force acting on the pinions 43 (helical gears) in their thrust direction.

A differential-lock switching sleeve 53 is arranged on a spline 41b formed at the outer peripheral portion of one end of the housing 41. As the differential-lock switching sleeve 53 is splined to the chain sprocket 44 and to a toothed wheel 54 fixed to the front output member 45 and coaxial with the housing 41, the housing 41 of the center differential 40 and the chain sprocket 44 are coupled with each other to rotate in the same direction, whereby the differential lock is locked, establishing a “rigid” four-wheel drive mode where no differential motion is allowed between the front wheels and the rear wheels. That is, the differential lock is ON when the differential-lock switching sleeve 53 is on the actuator 30 side, and it is OFF when the differential-lock switching sleeve 53 is on the side opposite from the actuator 30. Note that the housing 41 and the toothed wheel 54 in this example embodiment may be regarded as corresponding to “first gear” and “second gear” cited in the invention, and the position to which the differential-lock switching sleeve 53 is moved to lock the differential lock and the position to which the differential-lock switching sleeve 53 is moved to unlock the differential lock may be regarded as corresponding to “first position” and “second position” cited in the invention. The locking and unlocking of the differential lock are accomplished by moving a differential-lock switching shift folk 55 fixed on the differential-lock switching shift shaft 36. An attachment bracket 141 is secured to the output shaft 14, via which the output shaft 14 is attached to the rear propeller shaft 6b, and an attachment bracket 142 is secured to the driven-side chain sprocket 51, via which the driven-side chain sprocket 51 is attached to the front propeller shaft 6a. A bearing 101 supporting the cylindrical input shaft 21, a bearing 102 supporting the output shaft 14, and a bearing 103 supporting one end of the driven-side chain sprocket 51 are ball bearings, while a bearing supporting the other end of the driven-side chain sprocket 51 is a roller bearing.

Integrally formed at the portion of the transfer case 13 which the differential-lock switching shift shaft 36 penetrates is a stopper portion 18 that serves a positioning portion by setting the differential-lock switching sleeve 53 and the differential-lock switching shift folk 55 in their positions by contacting the differential-lock switching shift folk 55. More specifically, the stopper portion 18 contacts the differential-lock switching shift folk 55 as the differential-lock switching shift folk 55 moves toward the actuator 30 side (the right in FIG. 2) and thus defines the end of the movable range of the differential-lock switching shift folk 55, thereby positioning the differential-lock switching shift folk 55. Note that the differential-lock switching sleeve 53 and the differential-lock switching shift folk 55 in this example embodiment may be regarded as corresponding to “movable portion” cited in the invention.

Between the differential-lock switching shift folk 55 and the stopper portion 18, a buffer portion 82 slidable with respect to the differential-lock switching shift shaft 36 is provided to prevent the differential-lock switching shift folk 55 and the stopper portion 18 from making an impact noise when the differential-lock switching shift folk 55 moves to the actuator 30 side.

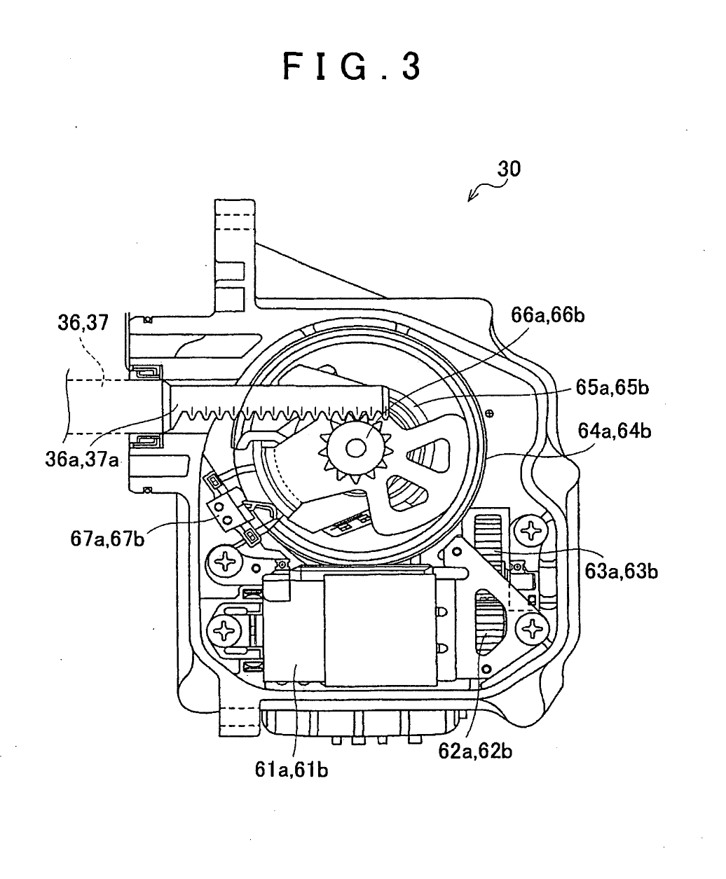

FIG. 3 is an enlarged view of an actuator of the drive power transfer apparatus of the first example embodiment of the invention. This actuator incorporates a structure for locking and unlocking the differential lock and a structure for switching the operation mode of the sub-transmission unit 20 between HIGH mode and LOW mode. The former structure is located on the near side in FIG. 3, and the latter structure is located on the far side in FIG. 3. For descriptive convenience, the elements of these two structures are denoted by the same reference numerals.

Referring to FIG. 3, in order to set the differential-lock switching shift folk 55, which is operated to lock or unlock the differential lock, in one of the two operation positions, the actuator 30 has a motor 61 to which an output gear 62b is secured, a speed-reduction gear 63b that decelerates the rotation speed of the output gear 62b; a worm wheel 64b that is rotated by the speed-reduction gear 63b, a spiral spring 65b one end of which is secured to the inner face of the worm wheel 64b, a pinion 66b to which the other end of the spiral spring 65b is secured and which is arranged at the center of the worm wheel 64b. The structure for locking and unlocking the differential lock is located on the near side in FIG. 3. The pinion 66b is in mesh with a rack 36a provided at one end of the differential-lock switching shift shaft 36. The worm wheel 64b is in mesh with and driven by a drive-side worm gear (not shown in the drawings) coupled with the speed-reduction gear 63b. The actuator 30 has detectors 67a, 67b for detecting the rotational positions of the worm wheels 64a, 64b, respectively.

Meanwhile, the actuator 30 also incorporates a structure for switching the operation mode of the sub-transmission unit 20 between HIGH mode and LOW mode by setting the H-L switching shift folk 35 in a selected one of the two operation positions. This structure is provided on the inner side of the aforementioned structure for locking and unlocking the differential lock. The structure for switching the operation mode of the sub-transmission unit 20 is constituted of a motor 61a to which an output gear 62a is secured, a speed-reduction gear 63a that decelerates the rotation speed of the output gear 62a, a worm wheel that is rotated by the speed-reduction gear 63a, a spiral spring 65a one end of which is secured to the inner face of a worm wheel 64a, a pinion 66a to which the other end of the spiral spring 65a is secured and which is arranged at the center of the worm wheel 64a. The pinion 66a is in mesh with a rack 37a provided at one end of the H-L switching shaft 37. The worm wheel 64a is in mesh with and driven by an worm gear (not shown in the drawings) coupled with the speed-reduction gear 63a.

In operation, a command is issued from the transfer ECU 70 in response to the HIGH-LOW switch 71 being operated by the operator, and the motor 61 a then rotates in accordance with the command from the transfer ECU 70. The rotation of the motor 61 a turns the worm wheel 64a via the output gear 62a and the speed-reduction gear 63a. The rotation of the worm wheel 64a turns the pinion 66a via the spiral spring 65a in the worm wheel 64a, moving the H-L switching shaft 37 to the actuator 30 side (the right in FIG. 3). Note that the spiral spring 65a is wound as the worm wheel 64a rotates, and the pinion 66a is turned by the accumulated urging force of the spiral spring 65a.

On the other hand, a command is issued from the transfer ECU 70 in response to the differential-lock switch 72 being operated by the operator, and the motor 61b rotates in accordance with the command from the transfer ECU 70. The rotation of the motor 61b turns the worm wheel 64b via the output gear 62b and the speed-reduction gear 63b. The rotation of the worm wheel 64b turns the pinion 66b via the spiral spring 65b in the worm wheel 64b, moving the differential-lock switching shift shaft 36 to the actuator 30 side (the right in FIG. 3). The spiral spring 65b is wound as the worm wheel 64b rotates, and the pinion 66b is turned by the accumulated urging force of the spiral spring 65b. Note that the structural elements for driving the H-L switching shift folk 35 and the structural elements for driving the differential-lock switching shift folk 55 may either be together disposed in a housing or disposed in separate housings.

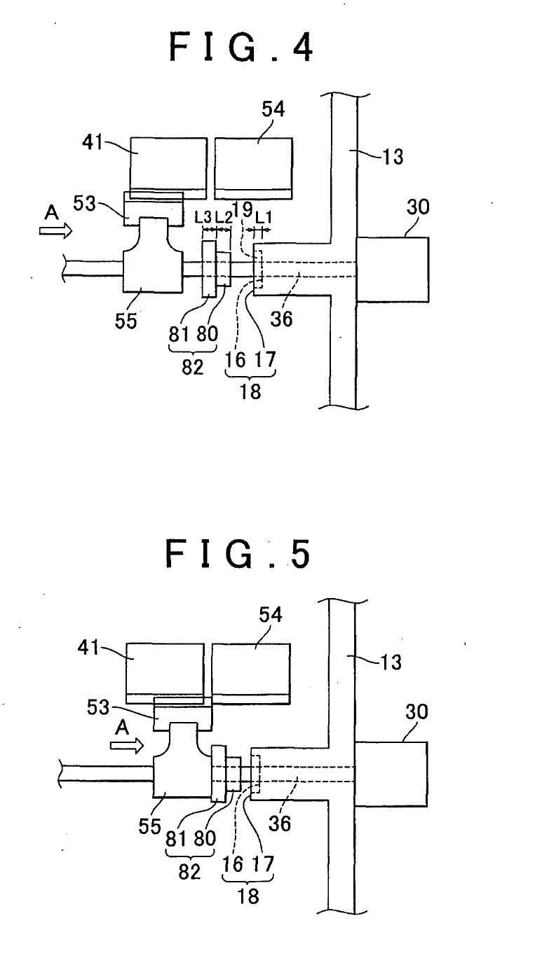

FIG. 4 is a view illustrating the state of the drive power transfer apparatus of the first example embodiment of the invention before the differential lock is switched from the unlocked state to the locked state. Referring to FIG. 4, the buffer portion 82 has the elastic portion 80 and a support portion 81 supporting the elastic portion 80. The elastic portion 80 is made of an elastic material (e.g., rubber, resin) and prevents the differential-lock switching shift folk 55 and the stopper portion 18 from contacting each other and thus prevent an impact noise when the differential-lock switching shift folk 55 moves to the actuator 30 side.

The support portion 81 supports the elastic portion 80 such that the elastic portion 80 does not deform nor break due to external forces. Further, the support portion 81 also serves, together with the stopper portion 18, to define the stop position of the differential-lock switching sleeve 53 such that the differential-lock switching sleeve 53 is splined to both the housing 41 and to the toothed wheel 54 via sufficient spline-contact lengths. The support portion 81 is made by forming metal into a cylindrical shape, and it is secured to the differential-lock switching shift folk 55 side face of the elastic portion 80 by adhesion, welding, fitting, and so on.

The stopper portion 18 has a first contact portion 16 and a second contact portion 17 that is provided around the first contact portion 16 and protrudes toward the differential-lock switching shift folk 55 more than the first contact portion 16 does. As the differential-lock switching sleeve 53 and the differential-lock switching shift folk 55 move together toward the actuator 30 side, the first contact portion 16 contacts the elastic portion 80 and the second contact portion 17 contacts the support portion 81. That is, in the first example embodiment of the invention, the stopper portion 18 has a concave portion 19, and the bottom face of the concave portion 19 forms the first contact portion 16, and the outer edges of the concave portion 19 form the second contact portion 17.

A thickness L2 of the elastic portion 80 in the axial direction is larger than a distance L1 between the first contact portion 16 and the second contact portion 17 in the axial direction. Thus, as the differential-lock switching sleeve 53 and the differential-lock switching shift folk 55 move together to the actuator 30 side, the elastic portion 80 enters the concave portion 19 and hits the first contact portion 16 of the stopper portion 18, whereby the elastic portion 80 is set in position. The thickness L2 of the elastic portion 80 and a thickness L3 of the support portion 81 in the axial direction are set such that, when the buffer portion 82 is in engagement with the stopper portion 18, the differential-lock switching sleeve 53 is splined to both the housing 41 and the toothed wheel 54 via sufficient spline contact lengths regardless of whether the elastic portion 80 has been worn or not. That is, when the elastic portion 80 has not yet been worn, the differential-lock switching shift folk 55 is set in the position that is L2−L1+L3 away from the second contact portion 17 of the stopper portion 18 in the axial direction. On the other hand, when the elastic portion 80 has been worn, the differential-lock switching shift folk 55 is set in the position that is L3 away from the second contact portion 17 of the stopper portion 18. As such, the stop position of the differential-lock switching sleeve 53 and the stop position of the differential-lock switching shift folk 55 shift by the distance of L2−L1 as the wearing of the elastic portion 80 progresses. However, the differential-lock switching sleeve 53 is splined to both the housing 41 and the toothed wheel 54 via sufficient spline-contact lengths even after said stop positions have shifted by the distance of L2−L1.

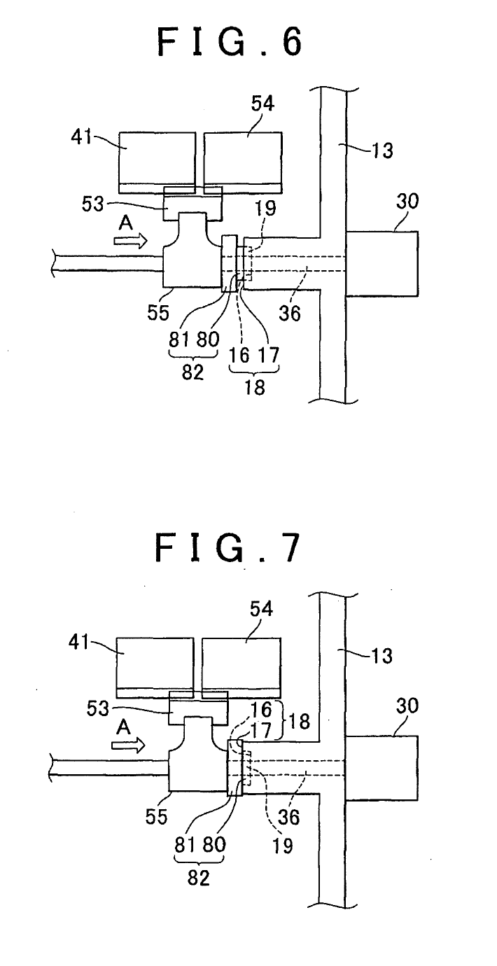

Next, the operation of the above-described drive power transfer apparatus will be described. FIG. 5 is a view illustrating the state of the drive power transfer apparatus of the first example embodiment of the invention where the deferential lock is being switched from the unlocked state to the locked state. FIG. 6 and FIG. 7 are views each illustrating a state of the drive power transfer apparatus of the first example embodiment of the invention after the differential lock has been switched from the unlocked sate to the locked state.

Referring to FIG. 5, as the motor 61b of the actuator 30 is driven in response to the command from the transfer ECU 80 when the differential lock is in the unlocked state as illustrated in FIG. 2 and. FIG. 4, the worm wheel 64b rotates and this winds the spiral spring 65b up. The urging force thus accumulated at the spiral spring 65b turns the pinion 66b, thus moving the differential-lock switching shift shaft 36 toward the actuator 30 side. As such, the differential-lock switching shift shaft 36 brings the differential-lock switching shift folk 55 and the differential-lock switching sleeve 53 toward the actuator 30 side. At this time, the differential-lock switching sleeve 53 stops once when the side face of the differential-lock switching sleeve 53 hits the corresponding side face of the toothed wheel 54 as shown in FIG. 5. Note that the actuator 30 is adapted to wind the spiral spring 65b by driving the motor 61b for a certain amount after the differential-lock switching sleeve 53 has thus stopped.

Then, referring to FIG. 6, when the phase of the spline of the differential-lock switching sleeve 53 and the phase of the spline of the toothed wheel 54 match each other in the state shown in FIG. 5, the differential-lock switching sleeve 53 and the differential-lock switching shift folk 55 restart moving toward the actuator 30 side under the urging force accumulated at the spiral spring 65b in the actuator 30, whereby the spline of the differential-lock switching sleeve 53 and the spline of the toothed wheel 54 engage each other. Then, when the differential-lock switching shift folk 55 contacts the stopper portion 18 via the buffer portion 82, the differential-lock switching sleeve 53 and the differential-lock switching shift folk 55 stop and thus are set in their positions. At this time, because the axial thickness L2 of the elastic portion 80 is larger than the axial distance L1 between the first contact portion 16 and the second contact portion 17 as described above, the elastic portion 80 of the buffer portion 82 contacts the first contact portion 16 of the stopper portion 18 but the support portion 81 does not contact the second contact portion 17. That is, when the elastic portion 80 has not yet been worn and therefore the axial thickness L2 of the elastic portion 80 is still larger than the axial distance L1 between the first contact portion 16 and the second contact portion 17 of the stopper portion 18, the differential-lock switching sleeve 53 is set in position by the first contact portion 16 contacting the elastic portion 80. As such, because the differential-lock switching shift folk 55 hits the stopper portion 18 via the buffer portion 82, no impact noise is made.

Meanwhile, referring to FIG. 7, when the axial thickness L2 of the elastic portion 80 has become equal to or smaller than the axial distance L1 between the first contact portion 16 to the second contact portion 17 due to wearing of the elastic portion 80, the first contact portion 16 only slightly contacts or does not contact the elastic portion 80. In this state, therefore, the differential-lock switching sleeve 53 is set in position by the second contact portion 17 contacting the support portion 81. The stop position of the differential-lock switching sleeve 53 set by such contact: between the second contact portion 17 and the support portion 81 depends on the axial thickness L3 of the support portion 81. As such, although the stop position of the differential-lock switching sleeve 53 shifts a slight distance toward the actuator 30 side as the elastic portion 80 is worn, because the differential-lock switching sleeve 53 is set in position by the second contact portion 17 contacting the support portion 81, the precision of the switching operation of the differential lock does not deteriorate, therefore it can be properly switched.

As mentioned above, the drive power transfer apparatus of the example embodiment of the invention has the elastic portion 80 provided between the differential-lock switching shift folk 55 and the stopper portion 18 and the support portion 81 provided between the differential-lock switching shift folk 55 and the elastic portion 80, and the stopper portion 18 has the first contact portion 16 that contacts the elastic portion 80 and the second contact portion 17 that protrudes toward the differential-lock switching shift folk 55 side more than the first contact portion 16 does and contacts the support portion 81, and the differential-lock switching shift folk 55 is set in position by the elastic portion 80 contacting the first contact portion 16. Therefore, the differential-lock switching shift folk 55 hits the stopper portion 18 via the buffer portion 82, and this prevents an impact noise when the differential lock is switched from the unlocked state to the locked state. Further, when the elastic portion 80 has been worn to an extent that that the elastic portion 80 does not contact the first contact portion 16 any more, the differential-lock switching shift folk 55 is set in position by the support portion 81 contacting the second contact portion 17, and therefore the precision of the switching operation of the differential lock is kept high even if the elastic portion 80 has been worn, and thus the differential lock can be properly switched from the unlocked state to the locked state.

According to the drive power transfer apparatus of the example embodiment of the invention, further, because the axial thickness L2 of the elastic portion 80 is larger than the axial distance between the first contact portion 16 and the second contact portion 17, when the elastic portion 80 has not yet been worn and thus the axial thickness L2 of the elastic portion 80 is still larger than the axial distance L1 between the first contact portion 16 and the second contact portion 17, the differential-lock switching sleeve 53 is set in position by the first contact portion 16 contacting the elastic portion 80, and due to the elastic portion 80, the differential-lock switching shift folk 55 and the stopper portion 18 do not make any impact noise. Further, when the elastic portion 80 has been worn, the differential-lock switching sleeve 53 is set in position by the second contact portion 17 contacting the support portion 81, and therefore the stop position of the differential-lock switching sleeve 53 slightly shifts toward the actuator 30 side as long as the elastic portion 80 has been worn as compared to before the wearing of the elastic portion 80. However, because in this state the differential-lock switching sleeve 53 is set in position by the second contact portion 17 contacting the support portion 81, the precision of the switching operation of the differential lock is kept high and therefore the differential lock can be properly switched from the unlocked state to the locked state.

According to the drive power transfer apparatus of the first example embodiment of the invention, further, because the elastic portion 80 and the support portion 81 are integrated with each other such that the support portion 81 supports the elastic portion 80, the elastic portion 80 does not deform nor break.

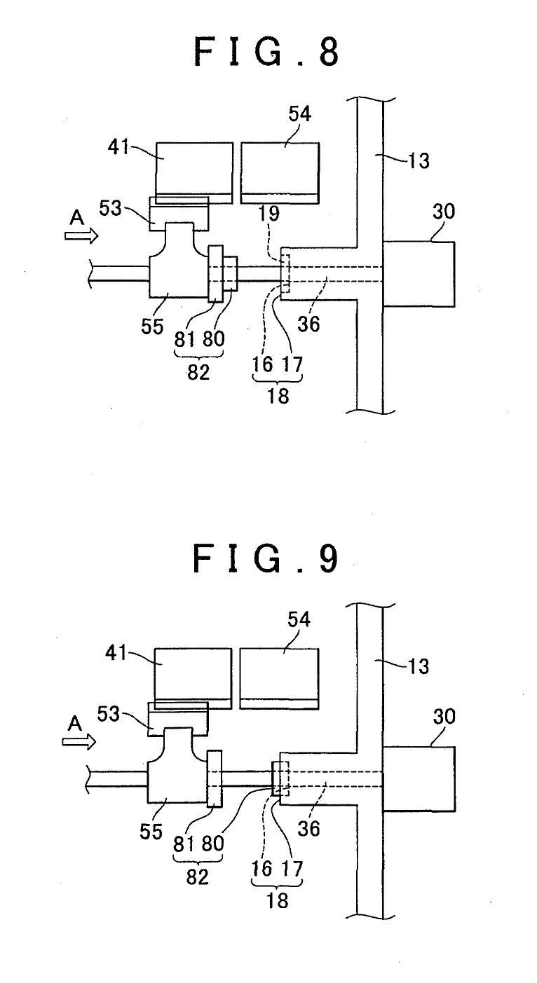

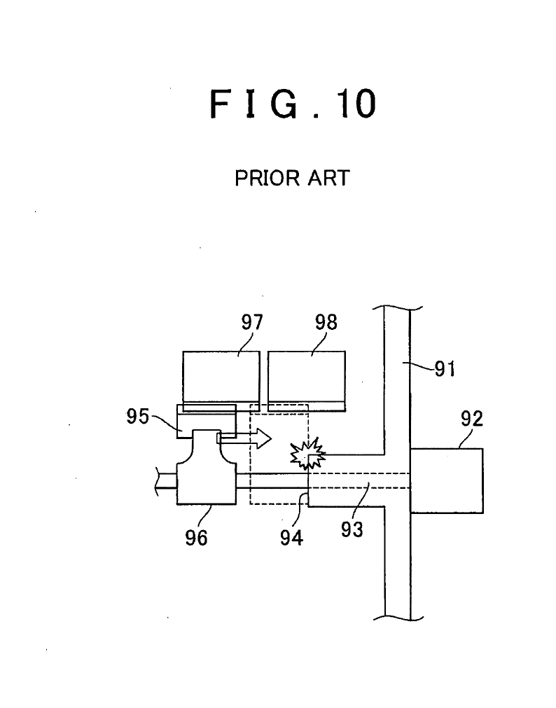

FIG. 8 is a view showing a deferential-lock switching mechanism of a drive power transfer apparatus according to the second example embodiment of the invention. Note that the structural elements identical to those of the drive power transfer apparatus are denoted by the same reference numerals and their descriptions are omitted.

In the example illustrated in FIG. 8, because the stand-by position of the buffer portion 82 (the elastic portion 80 and the support portion 81) before the differential-lock switching sleeve 53 and the differential-lock switching shift folk 55 move to the actuator 30 side is not defined as in the cases illustrated in FIG. 5 and FIG. 6 and thus said position can be freely set. Therefore, the support portion 81 and the differential-lock switching shift folk 55 may be secured to each other by welding, adhesion, or the like, or may be integrally formed. In this case, as the differential-lock switching shift folk 55 moves to the actuator 30 side, it is possible to prevent even a slight noise that may otherwise be caused if the differential-lock switching shift folk 55 and the support portion 81 contact each other. Note that the operations of the respective portions of the drive power transfer apparatus of the second example embodiment are the same as those of the drive power transfer apparatus of the first example embodiment.

According to the drive power transfer apparatus of the second example embodiment of the invention, as such, because the support portion 81 and the differential-lock switching shift folk 55 are integrated with each other, it is possible to prevent even a slight noise that may otherwise be caused if the differential-lock switching shift folk 55 and the support portion 81 contact each other as the differential-lock switching shift folk 55 moves to the actuator 30 side.

FIG. 9 is a view showing a deferential-lock switching mechanism of a drive power transfer apparatus according to the third example embodiment of the invention. Note that the structural elements identical to those of the drive power transfer apparatus are denoted by the same reference numerals and their descriptions are omitted.

In the example illustrated in FIG. 9, the support portion 81 and the differential-lock switching shift folk 55 are integrated with each other and the elastic portion 80 is secured to the first contact portion 16 of the stopper portion 18 by adhesion, etc. In this case, because the elastic portion 80 is supported by the first contact portion 16, the elastic portion 80 does not deform nor break, further, even a slight noise that may otherwise be caused when the differential-lock switching shift folk 55 and the support portion 81 contact each other can be prevented as in the case illustrated in FIG. 8. Note that the operations of the respective portions of the drive power transfer apparatus of the third example embodiment are the same as those of the drive power transfer apparatus of the first example embodiment.

According to the drive power transfer apparatus of the third example embodiment of the invention, as such, because the support portion 81 and the differential-lock switching shift folk 55 are integrated with each other and the elastic portion 80 is secured to the first contact portion 16 such that the elastic portion 80 is supported by the first contact portion 16, the elastic portion 80 does not deform nor break and even a slight noise that may otherwise be caused when the differential-lock switching shift folk 55 and the support portion 81 contact each other can be prevented.

The structures incorporated in the foregoing example embodiments of the invention are only exemplary and the invention is not limited to any of them. The scope of the invention is based on the claims as well as the foregoing example embodiments and is intended to cover all possible modifications and equivalent arrangements within the scope of the invention. For example, the elastic portion 80 may be made of a material strong enough not to deform nor break due to external forces. Further, the elastic portion 80 may be formed in a shape that provides the elastic portion 80 with a high strength. If the elastic portion 80 is thus made strong, it is not necessary to secure the elastic portion 80 to the first contact portion 16 of the stopper portion 18 such that the elastic portion 80 is supported by the stopper portion 18 as in the case illustrated in FIG. 9, and therefore impact noises can be prevented with a simpler structure. Further, the stopper portion 18 may be provided also at the position on the side opposite from the actuator 30 to which the differential-lock switching sleeve 53 is moved to unlock the differential lock, and the buffer portion 82 may be provided between the stopper portion 18 and the differential-lock switching shift folk 55. Further, the elastic portion 80 and the stopper portion 18 may be provided in the structure for switching the operation mode of the sub-transmission unit 20 between HIGH mode and LOW mode to prevent impact noises made upon switching of the sub-transmission unit 20. Further, as well as the transfer 10, the elastic portion 80 and the stopper portion 18 of the foregoing example embodiments may be provided also in any main transmission unit that shifts the transmission speed by moving a sleeve, or the like, using an actuator to prevent impact noises upon shifting.

As such, the drive power transfer apparatuses of the invention prevent impact noises when the switching mechanism is operated, and the invention can be advantageously applied to, for example, drive power transfer apparatuses that switch the operation mode of a sub-transmission unit between HIGH mode and LOW mode and switch a differential lock between the locked state and the unlocked state using an actuator or actuators.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A drive power transfer apparatus, comprising:
a first gear;
a second gear that is coaxial with the first gear;
a movable portion that is moved in an axial direction of the first gear and the second gear between a first position where the movable portion meshes with one of the first gear and the second gear and a second position where the movable portion meshes with both of the first gear and the second gear;
a driving device that moves the movable portion;
a positioning portion that sets the movable portion in one of the first position and the second position;
an elastic portion that is provided between the movable portion and the positioning portion;
a support portion that is provided between the movable portion and the elastic portion;
a first contact portion that contacts the elastic portion; and
a second contact portion that protrudes toward the movable portion more than the first contact portion does and that contacts the support portion, wherein the movable portion is set in one of the first position and the second position by the elastic portion contacting the first contact portion.

2. The drive power transfer apparatus according to claim 1, wherein
a thickness of the elastic portion in the axial direction is larger than a distance between the first contact portion and the second contact portion in the axial direction.

3. The drive power transfer apparatus according to claim 2, wherein
the elastic portion and the support portion are integrated with each other.

4. The drive power transfer apparatus according to claim 3, wherein
the support portion and the movable portion are integrated with each other.

5. The drive power transfer apparatus according to claim 1, wherein
the elastic portion and the support portion are integrated with each other.

6. The drive power transfer apparatus according to claim 5, wherein
the support portion and the movable portion are integrated with each other.

7. The drive power transfer apparatus according to claim 1, wherein
the support portion and the movable portion are integrated with each other, and the elastic portion is secured to the first contact portion.
